(19) United States
(12) Patent Application Publication
(10) Pub. No.: US 2012/0240723 A1
(43) Pub. Date: Sep. 27, 2012

(54) DRIVE TRAIN HAVING AN AUTOMATED AUXILIARY TRANSMISSION

(75) Inventors: Johannes Gluckler, Friedrichshafen (DE); Robert Januschevski, Tettnang (DE); Kai Borntrager, Langenargen (DE)

(73) Assignee: ZF FRIEDRICHSHAFEN AG, Friedrichshafen (DE)

(21) Appl. No.: 13/513,871

(22) PCT Filed: Nov. 22, 2010
(86) PCT No.: PCT/EP2010/067889

§ 371 Date: Jun. 5, 2012

(30) Foreign Application Priority Data
Dec. 16, 2009 (DE) 10 2009 054 752.5

(51) Int. Cl. F16H 37/06

(52) U.S. Cl. 74/661; 903/902; 180/65.22

(57) ABSTRACT

A drive train of a motor vehicle, having a hybrid drive comprising an internal combustion engine and an electric machine, and an automatic group transmission connected between the hybrid drive and an axle drive. The group transmission has at least a main gearing in a countershaft design, having a main shaft and at least one countershaft, a front-mounted group, particularly implemented as a splitter group, upstream in terms of drive technology of the main gearing, and/or a rear-mounted group, particularly implemented as a range group, downstream in terms of drive technology of the main gearing. An input shaft of the group transmission is connected, via a controllable startup clutch, to the internal combustion engine, and an output shaft of the group transmission is connected to the axle drive, and the electric machine of the hybrid drive is connected to the at least one countershaft.

This application is a National Stage completion of PCT/EP2010/067889 filed Nov. 22, 2010, which claims priority from German patent application serial no. 10 2009 054 752.5 filed Dec. 16, 2009.

### FIELD OF THE INVENTION

The invention relates to a drive train having an automatic group transmission. The invention further relates to a method for operating such a drive train.

### BACKGROUND OF THE INVENTION

Automatic transmissions designed as group transmissions having a multi-stage main gearing and a rear-mounted group down-stream in terms of drive technology of the main gearing and particularly implemented as a range group, and/or a front-mounted group upstream in terms of drive technology of the main gearing and particularly implemented as a splitter group, are known for example from the document DE 10 2007 010 829 A1, and are used in commercial vehicles for example. Due to a splitter group, implemented having two-stages for example, and having a transmission ratio change corresponding to approximately half of an average transmission ratio change between two subsequent transmission ratio steps of the main gearing, the transmission ratio changes of the main gearing are halved, and the total number of available gears is doubled. Due to a range group, designed having two stages for example, and having a transmission ratio change corresponding to an average transmission ratio step between two subsequent transmission ratio steps of the main gearing, extending across the total transmission ratio change of the main gearing, the transmission ratio spread of the group transmission is approximately doubled and the total number of available gears is again doubled.

The splitter group can be connected upstream or downstream of the main gearing, and accordingly can be implemented as a front-mounted group or a rear-mounted group. Likewise, the range group can be connected upstream or downstream of the main gearing, and accordingly can be implemented as a front-mounted group or a rear-mounted group. Automatic transmissions having shift elements that engage in a form-locking manner are distinguished from automatic power-shift transmissions having frictionally engaging shift elements.

With the automatic group transmissions known from the prior art, the main gearing has a countershaft design and comprises a main shaft and at least one countershaft. The front-mounted group and the rear-mounted group also have a countershaft design. When such an automatic group transmission is integrated into a drive train of a motor vehicle, an input shaft of the automatic group transmission, specifically of the front-mounted group, is connected via a controllable startup clutch to the drive assembly, and an output shaft of the automatic group transmission is connected to an axle drive. When the drive assembly is implemented purely as an internal combustion engine, the internal combustion engine, as already stated, is coupled via the startup clutch to the input shaft of the group transmission. When the drive assembly is implemented as a hybrid drive having an internal combustion engine and an electric machine, the electric machine is connected either, with the provision of a so-called crankshaft starter generator (KSG), between the internal combustion engine and the startup clutch, or, with the provision of a so-called integrated starter generator (ISG), between the startup clutch and the input shaft of the group transmission.

The drive trains known from the prior art that comprise an automatic group transmission as a transmission and a hybrid drive as a drive assembly having an internal combustion engine and an electric machine, have the disadvantage that no tractive force support can be provided during shifting in the group transmission, particularly during shifting in the splitter group, or the front-mounted group of the group transmission, which results in loss of comfort.

### SUMMARY OF THE INVENTION

Proceeding therefrom, the problem addressed by the present invention is to create a new type of drive train having an automatic group transmission.

This problem is solved by a drive train according to the invention. The electric machine of the hybrid drive according to the invention is connected to the, or each, countershaft of the group transmission.

With the drive train according to the invention, the electric machine of the hybrid drive is not connected between the internal combustion engine and the startup clutch, as is the case with a crankshaft starter generator (KSG), or between the startup clutch and the input shaft of the group transmission, as is the case with an integrated startup generator (ISG), rather the electric machine of the hybrid drive is coupled, or connected, to the, or each, countershaft of the group transmission. This can be implemented using a separate upstream stage or using a hollow shaft. When the electric machine of the hybrid drive, as proposed in the invention, is coupled to the, or each, countershaft, tractive force support can be provided during a shift in the group transmission, particularly during a shift in the splitter group thereof. This results in increased driving comfort.

### BRIEF DESCRIPTION OF THE DRAWINGS

Preferred further developments of the invention will become apparent from the description that follows. Example embodiments of the invention are explained in greater detail with reference to the drawing, without being limited thereto. Shown are:

FIG. 1 a diagram of a drive train according to the invention having a group transmission and a drive assembly and an axle drive according to a first example embodiment of the invention;

FIG. 2 a diagram of a drive train according to the invention having a group transmission and a drive assembly and an axle drive according to a second example embodiment of the invention;

FIG. 3 a possible power flow with the drive train of FIG. 1;

FIG. 4 a further possible power flow with the drive train of FIG. 1;

FIG. 5 a further possible power flow with the drive train of FIG. 1;

FIG. 6 a diagram of a drive train according to the invention having a group transmission and a drive assembly and an axle drive according to a third example embodiment of the invention;

FIG. 7 a diagram of a drive train according to the invention having a group transmission and a drive assembly and an axle drive according to a fourth example embodiment of the invention;

FIG. 8 a possible power flow with the drive train of FIG. 6;

FIG. 9 a further possible power flow with the drive train of FIG. 6; and

FIG. 10 a further possible power flow with the drive train of FIG. 6.

### DETAILED DESCRIPTION OF THE PREFERRED EMBODIMENTS

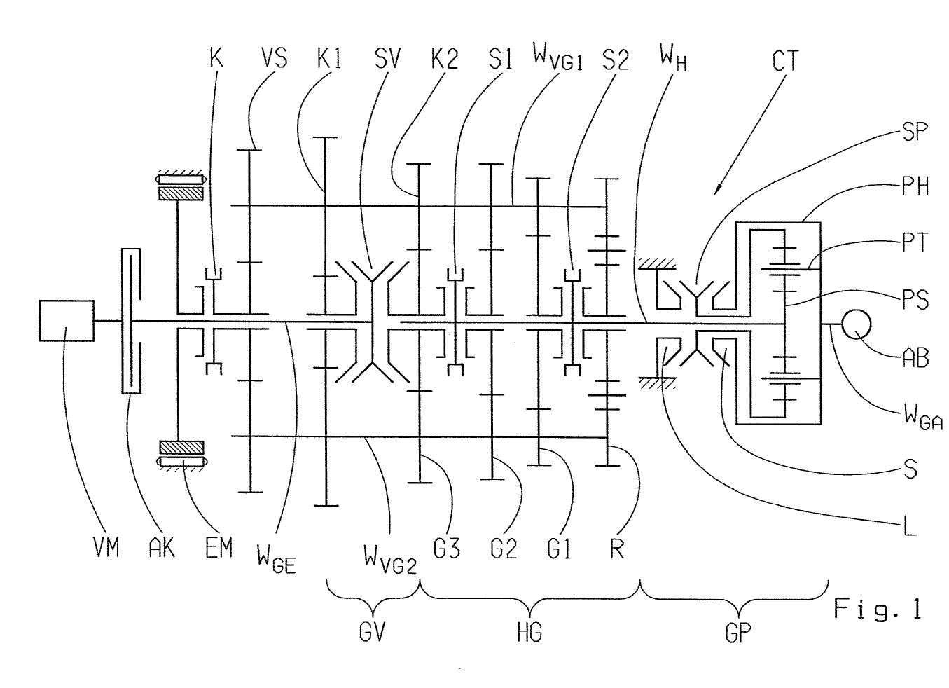

FIG. 1 shows a diagram of a group transmission CT together with an internal combustion engine VM of a hybrid drive, an electric machine EM of the hybrid drive and an axle drive AB. The group transmission CT shown in FIG. 1 comprises a main gearing HG, a front-mounted group upstream in terms of drive technology of the main gearing HG and particularly implemented as a splitter group GV, and a rear-mounted group down-stream in terms of drive technology of the main gearing HG and particularly implemented as a range group GP.

The main gearing HG of the group transmission CT of FIG. 1 is implemented as a direct gear transmission in a countershaft design, and comprises a main shaft W_{H} and two countershafts W_{VG1} and W_{VG2}.

The main gearing HG is designed with three steps, having three transmission ratio steps G1, G2, and G3 for forwards travel, and one transmission ratio step R for reverse travel. Idler gears of the transmission ratio steps G1, G2 and R are each mounted on the main shaft W_{H} in a rotational manner, and can be shifted via associated dog clutches. The associated fixed gears are disposed on the countershafts W_{VG1} and W_{VG2} in a rotationally fixed manner.

The highest transmission ratio step G3 of the main gearing HG, can be shifted via a direct shift clutch. The shift clutches of the transmission ratio steps G3 and G2 and the shift clutches of the transmission ratio steps G1 and R are each designed as dog clutches, and are combined into a common shift packet S1 and S2.

The front-mounted group of the group transmission CT of FIG. 1 designed as a splitter group GV is implemented with two stages, and also has a countershaft design, where the two transmission ratio steps K1 and K2 of the front-mounted group GV form two shiftable input constants of the main gearing HG. The front-mounted group GV is implemented as a splitter group due to a lower transmission ratio difference of the two transmission ratio steps K1, K2.

The idler gear of the first transmission ratio step K1 is mounted in a rotational manner on the input shaft W_{GE} which is connected to the internal combustion engine VM of the hybrid drive via a controllable startup clutch AK.

The idler gear of the second transmission ratio step K2 is mounted in a rotational manner on the main shaft W_{H}.

The fixed gears of the two transmission ratio steps K1, K2 of the front-mounted group, or splitter group GV, are each disposed in a rotationally fixed manner with countershafts W_{VG1} and W_{VG2} of the main gearing HG that are lengthened on the input side. The synchronized shift clutches of the front-mounted group GV are designed as dog clutches and are combined into a common shift packet SV.

The rear-mounted group of the group transmission CT of FIG. 1 implemented as a range group GP downstream of the main gearing HG is also designed having two-stages, however in planetary design with a simple planetary gear set. The sun gear PS is connected in a rotationally fixed manner to the main shaft W_{H} of the main gearing HG that is lengthened on the output side.

The planet carrier PT is coupled in a rotationally fixed manner to the output shaft W_{GA} of the group transmission CT, which is connected to an axle drive AB, shown by a dotted line.

The ring gear PH is connected to a shift packet SP by two synchronized shift clutches designed as dog clutches, by means of which the range group GP can be selectively shifted by connecting the ring gear PH to a fixed part of the housing in a slow driving step L, and by connecting the ring gear PH to the main shaft W_{H} or the sun gear PS in a fast driving step S.

The range group GP can be shifted synchronized.

The main gearing HG of such a group transmission CT is implemented as an unsynchronized main gearing, whereas the rear-mounted group, implemented as a range group GP, and the front-mounted group, implemented as a splitter group GV, are designed as synchronized transmission parts.

In the sense of the invention, the electric machine EM of the hybrid drive is coupled to the countershafts W_{VG1} and W_{VG2}, or connected thereto, namely in the example embodiment of FIG. 1 via an upstream stage VS, which is connected between the electric machine EM and the countershafts W_{VG1} and W_{VG2}, and according to FIG. 1 is implemented as a spur gear stage. The upstream stage VS implemented as a spur gear stage, by means of which the electric machine EM of the hybrid drive is coupled to the countershafts W_{VG1} and W_{VG2}, is implemented as a separate group, or stage, with respect to the front-mount group, or splitter group GV, upstream in terms of drive technology of the main gearing HG.

According to an advantageous further development of the invention, a controllable clutch K is connected between the electric machine EM of the hybrid drive and the group transmission CT, specifically in the example embodiment shown in FIG. 1, between the electric machine EM and the separate upstream stage VS, and via which clutch the electric machine EM can be coupled to, and decoupled from, the automatic group transmission CT. When this clutch K is disengaged, as shown in FIG. 1, the electric machine EM is decoupled from the group transmission CT, namely from the countershafts W_{VG1} and W_{VG2}, in contrast to when the clutch K is engaged where the electric machine EM of the hybrid drive is coupled to the two countershafts W_{VG1} and W_{VG2} of the group transmission CT. This clutch K is an optional assembly.

For coupling the electric machine EM of the hybrid drive to the automatic group transmission CT, specifically to the countershafts W_{VG1} and W_{VG2} of the same, the electric machine EM, using the rotational speed regulator thereof, is brought to the synchronization rotational speed with the dog clutch which according to FIG. 1 is implemented functioning in a form-locking manner.

Accordingly, the example embodiment of FIG. 1 shows a drive train having the hybrid drive and an automatic group transmission, in which the electric machine EM of the hybrid drive is coupled to the countershafts W_{VG1} and W_{VG2} of the group transmission CT, specifically via an additional upstream stage VS and a controllable clutch K connected between the additional upstream stage VS and the electric machine EM of the hybrid drive.

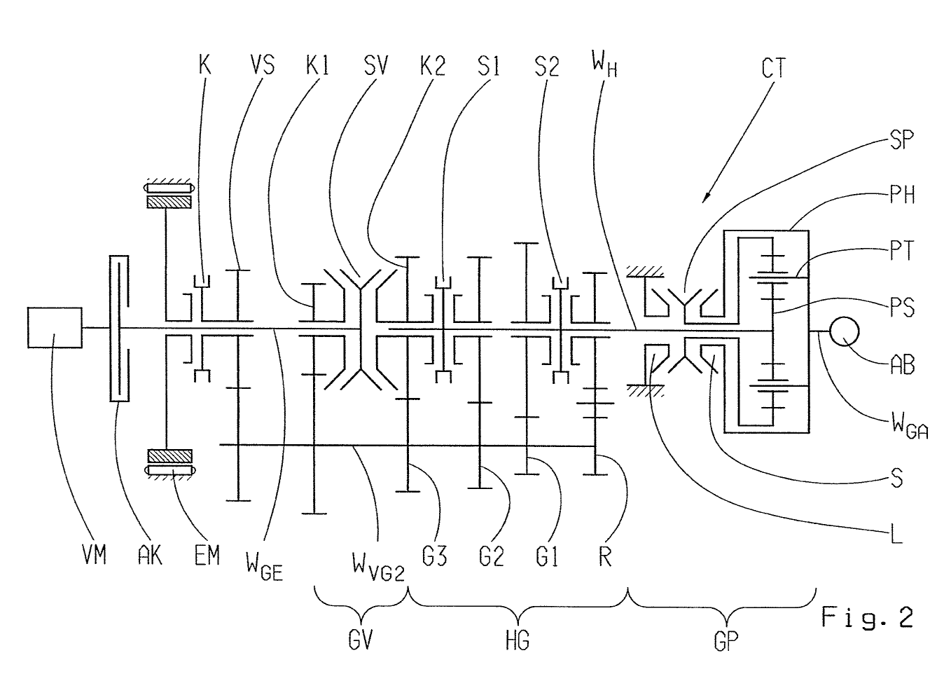

It is pointed out here that the group transmission CT of the drive train according to the invention, as shown in FIG. 2, can also comprise a single countershaft W_{VG2}. With respect to other details, the example embodiment of FIG. 2 is consistent with the example embodiment of FIG. 1, so that, to avoid unnecessary repetition, the same reference numbers are used for the same assemblies, and reference is made to the explanation for the example embodiment of FIG. 1. Thus, in the example embodiment of FIG. 2 also, the electric machine EM of the hybrid drive is coupled via an additional upstream stage VS to the countershaft W_{VG2}, here a single countershaft, wherein according to FIG. 2, preferably a clutch K is connected between the electric machine EM and the additional upstream stage VS, by means of which clutch the electric machine EM can be coupled to, or decoupled from, the countershaft W_{VG2}.

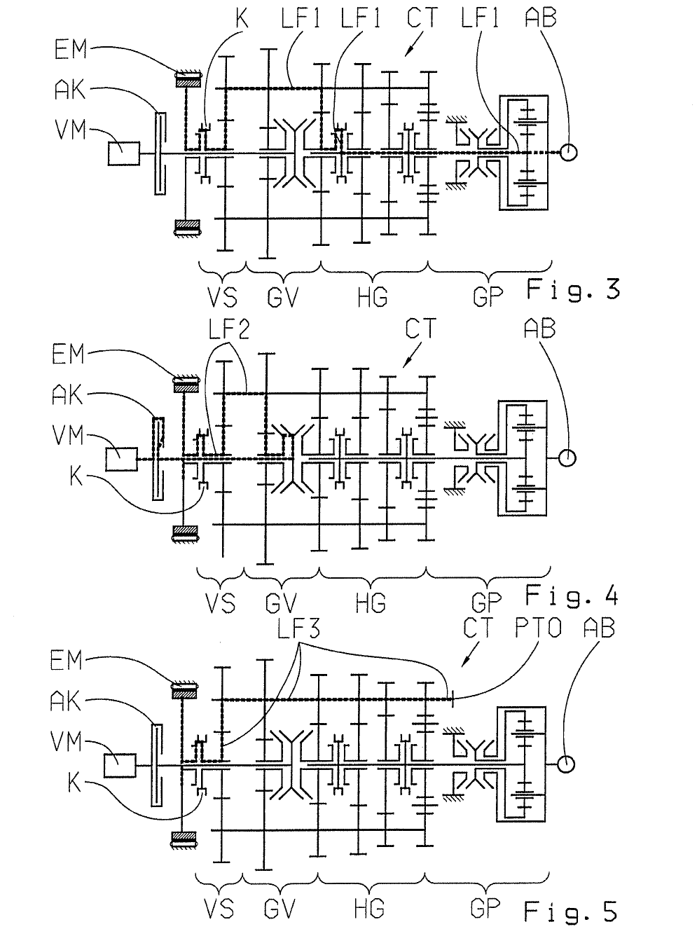

For the example embodiment of FIG. 1, the FIGS. 3 to 5 show possible power flows LF1, LF2 and LF3 that can occur in specific operating modes of the drive train of FIG. 1.

Thus, FIG. 3 shows a power flow LF1 that occurs in the drive train of FIG. 1, when shifting in the splitter group or front-mounted group VS upstream in terms of drive technology of the main gearing HG, a tractive force support is provided at the axle drive AB via the electric machine EM of the hybrid drive.

For shifting in the splitter group GV, the startup clutch AK is disengaged and the internal combustion engine VM of the hybrid drive is decoupled from the axle drive AB, where the electric machine EM of the hybrid drive remains coupled to the axle drive AB. During the entire shift procedure in the splitter group or front-mounted group GV, upstream of the main gearing HG, the electric machine EM with the engaged clutch K remains coupled to the countershafts W_{VG1} and W_{VG2} of the main gearing CT, and with it, coupled to the axle drive AB, where then, the main gearing HG has no neutral position, and no shifting is performed in the range group or rear-mounted group GP downstream in terms of drive technology of the main gearing HG. Then, while shifting, a tractive force support can be realized in the splitter group, or front-mounted group GV, upstream of the main gearing HG, using the power output of the electric machine EM of the hybrid drive. A synchronization of the splitter group, or front-mounted group GV during a shift procedure thereof is not more strongly loaded because so-called inertia of the electric machine EM of the hybrid drive does not act on the input shaft W_{GE} of the transmission, but rather on the countershafts W_{VG1} and W_{VG2}.

FIG. 4 illustrates a signal flow LF2 for the drive train of FIG. 1, which occurs in the generator mode of the electric machine EM in the case of a motor vehicle at a standstill. In this case, the electric machine EM of the hybrid drive is driven by the internal combustion engine VM thereof, wherefore then the startup clutch AK and the clutch K are engaged, and similarly force can be transferred also in the splitter group, or front-mounted group GV, upstream of the main gearing HG. A drive connection between the internal combustion engine VM and the axle drive AB is disconnected, for example, in that the main gearing HG takes on a neutral position.

In a manner analogous to FIG. 4, in standstill of the drive train, or motor vehicle, another electric consumer can also be supplied with energy from the internal combustion engine VM. Other electric consumers are also designated as auxiliary electric consumers, which analogously to FIG. 4, in the standstill of the motor vehicle can thereby be driven by the internal combustion engine VM of the hybrid drive, in that there is a drive connection between the internal combustion engine VM and the respective auxiliary electric consumer, where in contrast, the drive connection between the internal combustion engine VM and the axle drive AB is disconnected.

When the auxiliary electric consumers are to be driven by the internal combustion engine VM of the hybrid drive for providing energy while the motor vehicle is traveling, there is both a drive connection between the internal combustion engine VM and the respective auxiliary electric consumer as well as between the internal combustion engine VM and the axle drive AB, such that there is a power split originating from the internal combustion engine VM to the respective auxiliary electric consumer and to the axle drive AB.

FIG. 5 illustrates a power flow LF3 for the drive train of FIG. 1, in which a mechanical power take off PTO (Power Take Out) is to be driven using the electric machine EM of the hybrid drive. Such a mechanical power take off PTO is coupled, as shown in FIG. 5, to one of the countershafts of the group gearing CT, specifically according to FIG. 5, coupled to the countershaft W_{VG1}, where according to FIG. 5, the mechanical power take off PTO can be driven solely by the electric machine EM of the hybrid drive. For this purpose, the main gearing HG takes on a neutral position, where during vehicle standstill the startup clutch AK is also disengaged.

Furthermore, energy recovery can be realized with the drive train of FIG. 1 through recovery or recuperation, where during energy recovery, braking is primarily performed with the electric machine EM of the hybrid drive in order to operate the electric machine as a generator, where for this purpose, electrical energy is stored in an energy accumulator of the hybrid drive, not shown here, to be used selectively as required for driving the electric machine EM of the hybrid drive, in order to provide drive torque at the axle drive AB, for example, or to drive consumers or auxiliary consumers of the drive train. During recuperation, there is a drive connection between the axle drive AB and the electric machine EM of the hybrid drive, in order to convert mechanical braking energy occurring during braking at the axle drive AB into electrical energy at the electric machine EM of the hybrid drive.

Furthermore, with the drive train of FIG. 1 it is possible during travel with balanced driving resistance to decouple the internal combustion engine VM of the hybrid drive from the axle drive AB by disengaging the startup clutch AK and subsequently switching off the internal combustion engine VM for fuel savings. Here, the electric machine EM remains permanently coupled to the axle drive AB, or the countershafts W_{VG1} and W_{VG2}.

If subsequently, the internal combustion engine VM is to be recoupled to the axle drive AB, then successively, the internal combustion engine VM is initially started or tow-started with a main gearing HG in the neutral position, namely using the electric machine EM of the hybrid drive. The electric machine EM then drives the internal combustion engine VM in the function of a starter motor, wherein when a synchronization rotational speed is produced for the internal combustion engine VM, the startup clutch AK can be engaged.

Alternatively, the internal combustion engine VM can also be started using a so-called dynamic start during travel by using the kinetic energy of the vehicle, where then the electric machine EM of the hybrid drive compensates the starting torque required for tow-starting the internal combustion engine VM, while the startup clutch AK is engaged in order to guarantee driving comfort. In the process then, the main gearing HG of the group transmission CT is not in the neutral state, but rather in a force or torque transferring shift position, where the rear-mounted group, or range group GP, designed as a planetary transmission, is preferably operated in so-called block rotation as a whole with a transmission ratio of one, and in the group transmission CT, a suitable transmission ratio is selected for the driving speed in order to avoid over-revving the internal combustion engine VM.

Furthermore, the drive train of FIG. 1 can be driven purely electrically using the electric machine EM of the hybrid drive with partial use of a transmission ratio spread of the group transmission CT, wherein with a disengaged startup clutch AK, depending on the type of the group transmission CT, gears of the main gearing HG, the splitter group, or front-mounted group GV, and/or the rear-mounted group, or range group GP, are available.

All operating modes described above of the drive train of FIG. 1, thus, recuperation, or recovery, providing tractive force support while shifting, supplying auxiliary electric consumers via the internal combustion engine, supplying the mechanical auxiliary consumers, switching off and subsequent switching on of the internal combustion engine, and the purely electric travel with the partial use of the transmission ratio spread of the group transmission CT, can be used in an analogous manner with the drive train of FIG. 2, which, as already explained, differs from the drive train of FIG. 1 only in that it has a single countershaft and not two countershafts as in FIG. 1.

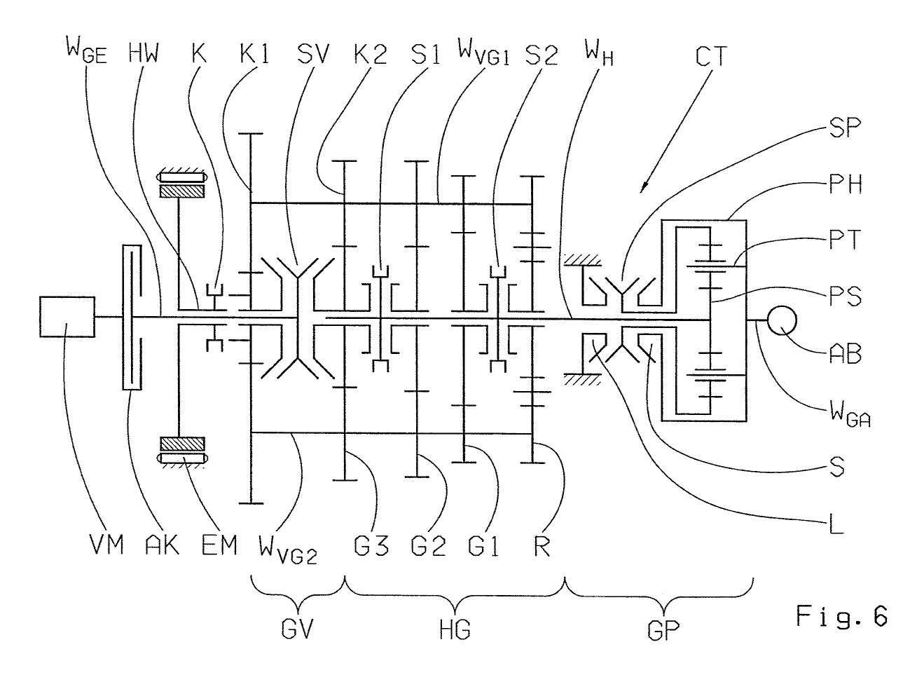

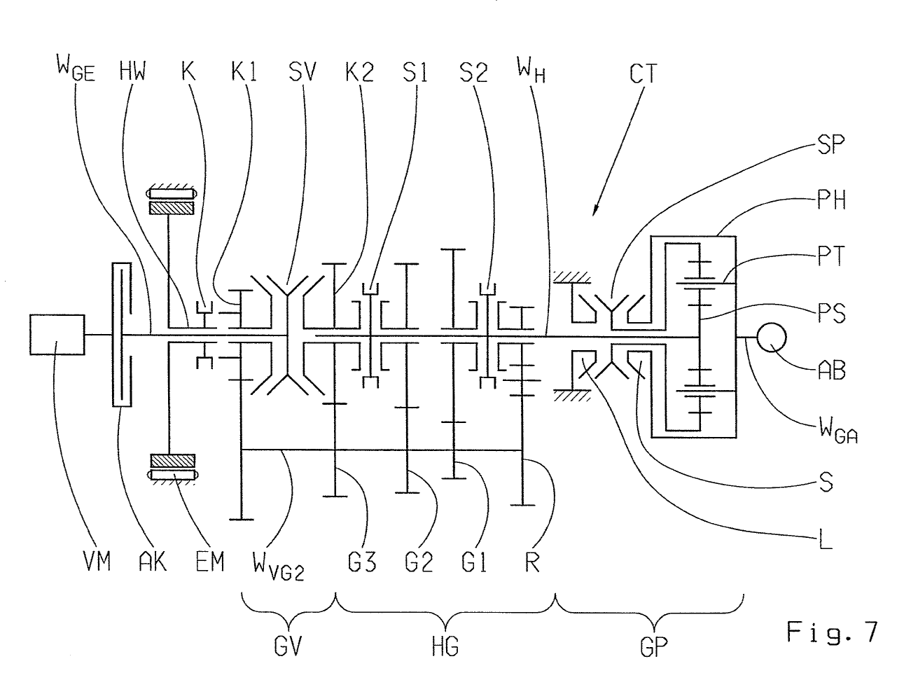

FIG. 6 and FIG. 7 show further example embodiments of drive trains according to the invention, wherein FIG. 6 shows an example embodiment having two countershafts W_{VG1} and W_{VG2}, and FIG. 7 shows an example embodiment having a single countershaft W_{VG2}.

With the example embodiments of FIGS. 6 and 7, in each case, as with the example embodiments of FIGS. 1 and 2, the electric machine EM of the hybrid drive is coupled or connected to the, or each, countershaft W_{VG1}, W_{VG2} of the group transmission CT, wherein in the example embodiment of FIGS. 1 and 2, however, no separate upstream stage VS is present for this purpose, rather in the example embodiment of FIGS. 6 and 7, the electric machine EM is coupled or connected to the, or each, countershaft W_{VG1}, W_{VG2} using an additional hollow shaft HW, which produces a direct connection between the electric machine EM and a transmission ratio step K1 of the splitter group, or front-mounted group GV, that is technically upstream of the main gearing HG.

In the example embodiments of FIGS. 6 and 7, as in the example embodiments of FIGS. 1 and 2, preferably a clutch K is present by means of which the electric machine EM of the hybrid drive can be coupled to, or decoupled from, the, or each, countershaft W_{VG1}, W_{VG2} of the group transmission CT.

This clutch K is again a dog clutch which, when it is engaged, provides a direct connection of the electric machine EM to the splitter group, or front-mounted group GV. When, in contrast, the clutch K is disengaged, the electric machine EM of the hybrid drive is decoupled from the splitter group, or front-mounted group GV, specifically from the, or each, countershaft W_{VG1}, W_{VG2}.

Accordingly, the example embodiments of FIGS. 6 and 7 differ from the example embodiments of FIGS. 1 and 2 only in that, in the example embodiments of FIGS. 6 and 7, the electric machine EM is coupled to the, or each, countershaft W_{VG1}, W_{VG2} of the group transmission CT not using a separate upstream stage VS, but rather using a hollow shaft HW which produces a direct connection between the electric machine EM and the, or each, countershaft.

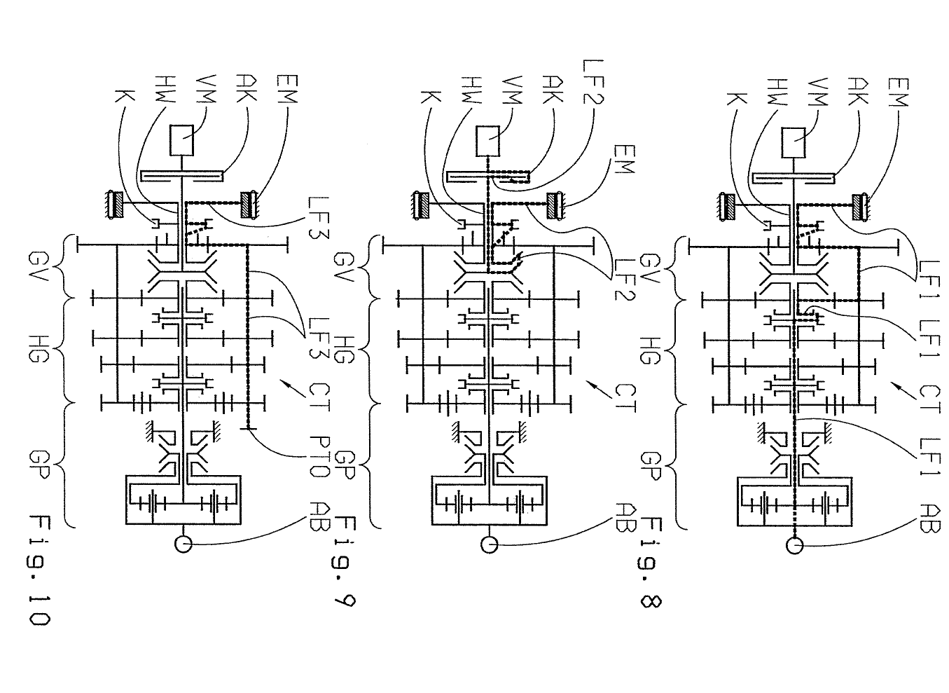

There are no differences with respect to the remaining details and the operating modes that can be realized with the drive train, wherein the operating modes shown in FIGS. 8 to 10 of the drive train of FIG. 6 correspond to the operating modes shown in FIGS. 3 to 5 of the drive train of FIG. 1. In order to avoid unnecessary repetition, reference is made to the above explanation, wherein the operating modes are also applicable to the example embodiment of FIG. 7, which is characterized by a single countershaft W_{VG2}. The power flows LF1 of the operating modes of FIGS. 3 and 8, the power flows LF2 of the operating modes of FIGS. 4 and 9, and the power flows LF3 of the operating modes of FIGS. 5 and 10, correspond to each other in the principal of operation thereof.

In the example embodiments shown, the electric machine EM can in each case be constructed coaxially flanged on the primary side to a so-called clutch case of the group transmission CT.

The recovery of braking energy with recuperation is possible with the present invention. The driving comfort can be increased by providing tractive force support during shifting procedures in the group transmission, particularly in the splitter group of the group transmission. By boosting with the electric machine, downshifts can be avoided for a limited time.

Purely electric travel is possible with partial use of the transmission ratio spread of the group transmission. By shifting the operating point of the electric machine, electric energy can be saved, namely in that the operating points of the electric machine are shifted into a higher range. Electric energy can be provided for an auxiliary electric consumer, for example, while the vehicle is traveling and during standstill, using the electric machine of the hybrid drive.

Furthermore, mechanical auxiliary consumers can be driven directly using the electric machine. Fuel can be saved by switching off the internal combustion engine during travel with balanced drive resistance.

Furthermore, fuel savings can be realized by a targeted shift of the operating points of the internal combustion engine. The electric machine can be synchronized using the rotational speed regulator thereof, or alternatively using the group transmission. The electric machine can be decoupled from the countershafts in order to avoid electric machine no-load losses.

### REFERENCE CHARACTERS

AB axle drive
AK startup clutch
CT group transmission
EM electric machine
G1 forward travel transmission ratio step
G2 forward travel transmission ratio step
G3 forward travel transmission ratio step
GV splitter group
GP range group
HG main gearing
HW hollow shaft
K clutch
K1 transmission ratio step
K2 transmission ratio step
L slow driving step
LF1 power flow
LF2 power flow
LF3 power flow
PS sun gear
PT planet carrier
PTO power take off
PH ring gear
R reverse travel transmission ratio step
S fast driving step
S1 shift packet
S2 shift packet
SP shift packet
SV shift packet
VM internal combustion engine
VS upstream stage
W_{GA} output shaft
W_{GE} input shaft
W_{H} main shaft
W_{VG1} countershaft
W_{VG1} countershaft

1-14. (canceled)

15. A drive train of a motor vehicle comprising:
a hybrid drive comprising an internal combustion engine (VM) and an electric machine (EM), and an automatic group transmission (CT) connected between the hybrid drive and an axle drive (AB),
the automatic group transmission (CT) having at least one main gearing (HG) in a countershaft design having a main shaft (W_{H}) and at least one countershaft (W_{VG1}, W_{VG2}),
at least one of a front-mounted group (GV) being located upstream, in terms of drive technology, of the main gearing (HG) and designed as a splitter group,
a rear-mounted group (GP) being located downstream, in terms of drive technology, of the main gearing (HG) and designed as a range group, an input shaft (W_{GE}) of the automatic group transmission (CT) being connected, via a controllable startup clutch (AK), to the internal combustion engine (VM) of the hybrid drive,
an output shaft (W_{GA}) of the automatic group transmission (CT) being connected to the axle drive (AB), and
the electric machine (EM) of the hybrid drive being connected to the at least one countershaft (W_{VG1}, W_{VG2}).

16. The drive train according to claim 15, wherein a controllable second clutch (K) is connected between the electric machine (EM) and the at least one countershaft (W_{VG1}, W_{VG2}), by the second clutch, and the electric machine (EM) is coupleable to, and decoupleable from, the automatic group transmission (CT).

17. The drive train according to claim 16, wherein the controllable second clutch (K) is a dog clutch, and the electric machine (EM) is brought to a synchronization rotational speed for the dog clutch by a rotational speed regulator thereof for coupling the electric machine (EM) to the automatic group transmission (CT).

18. The drive train according to claim 16, wherein the electric machine (EM) of the hybrid drive is coupled to the at least one countershaft (W_{VG1}, W_{VG2}) using an upstream stage (VS).

19. The drive train according to claim 18, wherein the upstream stage (VS), which is coupled between the electric machine (EM) and the at least one countershaft (W_{VG1}, W_{VG2}) is a spur gear stage, and is either a separate group or a stage with respect to the front-mounted group (GV) upstream, in terms of drive technology, of the main gearing (HG).

20. The drive train according to claim 16, wherein the electric machine) (EM) of the hybrid drive is coupled to the at least one countershaft (W_{VG1}, W_{VG2}) via a hollow shaft (HW).

21. The drive train according to claim 20, wherein using the hollow shaft (HW) there is a direct connection to a first transmission ratio step (K1) of the front-mounted group (GV) upstream, in terms of drive technology, of the main gearing (HG).

22. A method of operating a drive train of a motor vehicle, having a hybrid drive comprising an internal combustion engine (VM) and an electric machine (EM), and an automatic group transmission (CT) connected between the hybrid drive and an axle drive (AB), the automatic group transmission (CT) having at least one main gearing (HG) in a countershaft design having a main shaft (W_{H}) and at least one countershaft (W_{VG1}, W_{VG2)}, at least one of a front-mounted group (GV) being located upstream, in terms of drive technology, of the main gearing (HG) and designed as a splitter group, and a rear-mounted group (GP) being located downstream, in terms of drive technology, of the main gearing (HG) and designed as a range group, an input shaft (W_{GE}) of the automatic group transmission (CT) being connected, via a controllable startup clutch (AK), to the internal combustion engine (VM) of the hybrid drive, and an output shaft (W_{GA}) of the automatic group transmission (CT) being connected to the axle drive (AB), the electric machine (EM) of the hybrid drive being connected to the at least one countershaft (W_{VG1}, W_{VG2}), the method comprising the steps of:
supplying an electric consumer with energy, by driving the electric consumer with the internal combustion engine (VM), when the motor vehicle is at a standstill;
shifting the group transmission (CT) to form a drive connection between the internal combustion engine (VM) and the electric consumer;
disconnecting a drive connection between the internal combustion engine (VM) and the axle drive (AB);
shifting the group transmission (CT), when the motor vehicle is traveling, to form a drive connection between the internal combustion engine (VM) and the electric consumer, and the internal combustion engine (VM) being drivingly connected to the axle drive (AB).

23. The method of operating a drive train according to claim 22, further comprising the step of primarily performing braking, during energy recovery with the electric machine (EM) of the hybrid drive, for which purpose the group transmission (CT) is shifted to form a drive connection between the axle drive (AB) and the electric machine (EM).

24. The method of operating a drive train according to claim 22, further comprising the step of providing tractive force support during shifting in the front-mounted group, via the electric machine (EM) of the hybrid drive, for which purpose the internal combustion engine (VM) of the hybrid drive is coupled to the axle drive (AB), the electric machine (EM) of the hybrid drive remains coupled to the axle drive (AB), while no neutral position is present in the main gearing (HG) and no shifting is performed in the rear-mounted group (GP).

25. The method of operating a drive train according to claim 22, further comprising the step of decoupling the internal combustion engine (VM) from the axle drive (AB), during travel of the motor vehicle and with balanced drive resistance, by disengaging the startup clutch (AK), and subsequently switching off the internal combustion engine (VM), and the electric machine (EM) remaining coupled to the axle drive (AB).

26. The method of operating a drive train according to claim 25, further comprising the step of tow starting the internal combustion engine (VM), with the main gearing (HG) set into the neutral position and engaging the startup clutch (AK) for coupling of the internal combustion engine (VM) to the axle drive (AB).

27. The method of operating a drive train according to claim 25, further comprising the step of subsequently coupling the internal combustion engine (VM) to the axle drive (AB), during travel, using the kinetic energy of the vehicle by engaging the startup clutch (AK) to start the internal combustion engine (VM) with the main gearing (HG) not transferred into the neutral position, the electric machine (EM) compensates the torque required to tow-start the internal combustion engine (VM) while the startup clutch (AK) is engaging.

28. The method of operating a drive train according to claim 22, further comprising the step of supplying a mechanical auxiliary consumer (PTO) with energy by driving the auxiliary consumer with the electric machine (EM) of the hybrid drive.

29. A drive train of a motor vehicle, the drive train comprising:
a hybrid drive comprising an internal combustion engine and an electric machine;
an automatic group transmission comprising a main gearing group, a splitter group being located upstream from the main gearing group with respect to a flow of drive through the automatic group transmission, and a range group being located downstream from the main gearing group with respect to the flow of drive through the automatic group transmission,
the main gearing group having a main shaft and at least one countershaft;
an input shaft of the automatic group transmission being connected, via a controllable startup clutch, to the internal combustion engine and an output shaft of the automatic group transmission being continuously connected to the axle drive; and
the electric machine of the hybrid drive is connected to the at least one countershaft such that the flow of drive from the electric machine to the at least one countershaft bypasses the input shaft of the automatic group transmission and the flow of drive from the internal combustion engine only passes into the automatic group transmission via the input shaft.
